(19) United States
(12) Patent Application Publication
(10) Pub. No.: US 2025/0136625 A1
(43) Pub. Date: May 1, 2025

(54) PROCESS FOR THE PREPARATION OF ORGANIC SILICON COMPOUNDS

(71) Applicant: BASF SE, Ludwigshafen am Rhein (DE)

(72) Inventors: Andreas Haas, Ludwigshafen am Rhein (DE); Jan Niclas Gorges, Ludwigshafen am Rhein (DE)

(73) Assignee: BASF SE, Ludwigshafen am Rhein (DE)

(21) Appl. No.: 18/835,940

(22) PCT Filed: Feb. 1, 2023
(86) PCT No.: PCT/EP2023/052428

§ 371 Date: Aug. 5, 2024

(30) Foreign Application Priority Data
Feb. 9, 2022 (EP) 22155937.0

(51) Int. Cl. C07F 7/18

(52) U.S. Cl. CPC C07F 7/1876

(57) ABSTRACT

Organic silicon compounds synthesized by a method for preparing such organic silicon compounds can act as or in functional fluids and for trapping water. The method includes reacting at least one alkoxy alkyl silane of the formula (Ia) and/or a cyclic siloxane of the formula (Ib) with at least one alkoxy alkanol of the formula (II). The reaction occurs in the presence of at least one acid or at least one base, optionally in a solvent, at a temperature of 0 to 200° C.

The present invention relates to a method for preparing organic silicon compounds and to the use of the compounds thus obtained.

Polysiloxanes are known as constituents of hydraulic fluids or certain brake fluids that meet the DOT 5 standard of the US Department of Traffic.

U.S. Pat. No. 3,814,691 describes the preparation of such organosilanes by reacting the corresponding alkyl silyl chlorides with the desired alcohols, which may be glycol ethers.

However, a disadvantage of the organosilanes obtained by this reaction is the residual content of chlorides, which can cause corrosion in the hydraulic system, which can result in leaks under the high pressures prevailing in the system.

EP 557027 A1 describes a multistep process in which a polysiloxane is first reacted with an alcohol in the presence of a catalyst, the catalyst is removed, and is then reacted with a glycol and glycol ether.

A disadvantage of this reaction regime is that, in the first reaction step, a high proportion of a high-molecular-weight residue is formed that cannot be used in the reaction with the glycol and glycol ether. US 2015/0221986 A1 describes the preparation of organic silicon compounds by reacting different alkoxy alkanols with for example hexamethylcyclotrisilazane or alkoxy silanes. A disadvantage of preparation from hexamethylcyclotrisilazane is the high chlorine content associated with this method of preparation.

The object was to provide a method for preparing chlorine-free organic silicon compounds with which the products can be obtained in high yield and purity so that the reaction mixtures are as far as possible ready for use in their applications.

The object was achieved by a method for preparing organic silicon compounds of the formula (III)

R¹ₓSi(—[—O—CH₂—CH₂—]ₙ—O—R³)₄₋ₓ (III)
or mixtures thereof,
in which at least one alkoxy alkyl silane of the formula (Ia)

R¹ₓSi(OR²)₄₋ₓ (Ia)
and/or a cyclic siloxane of the formula (Ib)

—(—SiR¹₂—O—)_{y}— (Ib)
is reacted with at least one alkoxy alkanol of the formula (II)

R³—O—[—CH₂—CH₂—O—]ₙ—H (II)
in the presence of at least one acid or at least one base,
optionally in a solvent,
at a temperature of 0 to 200° C.,
wherein
R¹ is phenyl or C₁-C₄ alkyl, preferably C₁-C₄ alkyl, more preferably methyl, ethyl or n-butyl, most preferably methyl or ethyl,
R² is C₁-C₄ alkyl, more preferably methyl, ethyl or n-butyl, most preferably methyl or ethyl,
R³ is C₁-C₄ alkyl, more preferably methyl, ethyl or n-butyl,
x is a positive integer 1, 2 or 3,
y is a positive integer 3 or 4, preferably 3, and
n is a positive integer from 2 to 5, preferably from 2 to 4, more preferably 2 or 3, and most preferably 3.

The starting compounds of the formula (Ia)

R¹ₓSi(OR²)₄₋ₓ (Ia)
may be monoalkoxy trialkyl silanes (x=3), dialkoxy dialkyl silanes (x=2), trialkoxy monoalkyl silanes (x=1) or mixtures thereof. When the radical R′ is phenyl, these are the corresponding monoalkoxy triphenyl silanes, dialkoxy diphenyl silanes, and trialkoxy monophenyl silanes respectively.

For the sake of simplicity, the compounds of the formula (Ia) are referred to in the text as alkoxy alkyl silanes even when they contain a phenyl group as the radical R¹.

When the compounds of the formula (Ia) are used in the form of a mixture, the organic silicon compounds of the formula (III) are likewise obtained in the form of a mixture. The ratio of the compounds of the formula (Ia) generally corresponds here to the ratio of the proportions of the individual compounds of the formula (III) in the mixture.

Preferred compounds of the formula (Ia) where x=1 are methyltrimethoxysilane, methyltriethoxysilane, methyltri-n-butoxysilane, ethyltrimethoxysilane, ethyltriethoxysilane, ethyltri-n-butoxysilane, n-propyltrimethoxysilane, n-propyltriethoxysilane, n-propyltri-n-butoxysilane, n-butyltrimethoxysilane, n-butyltriethoxysilane, n-butyltri-n-butoxysilane, phenyltrimethoxysilane, phenyltriethoxysilane, and phenyltri-n-butoxysilane.

More preferred are methyltrimethoxysilane, methyltriethoxysilane, ethyltrimethoxysilane, and ethyltriethoxysilane, most preferred are methyltrimethoxysilane and ethyltrimethoxysilane.

Preferred compounds of the formula (Ia) where x=2 are dimethyldimethoxysilane, dimethyldiethoxysilane, dimethyldi-n-butoxysilane, diethyldimethoxysilane, diethyldiethoxysilane, diethyldi-n-butoxysilane, di-n-propyldimethoxysilane, di-n-propyldiethoxysilane, di-n-propyldi-n-butoxysilane, di-n-butyldimethoxysilane, di-n-butyldiethoxysilane, di-n-butyldi-n-butoxysilane, diphenyldimethoxysilane, diphenyldiethoxysilane, and diphenyldi-n-butoxysilane.

More preferred are dimethyldimethoxysilane, dimethyldiethoxysilane, diethyldimethoxysilane, and diethyldiethoxysilane, most preferred are dimethyldimethoxysilane and dimethyldiethoxysilane.

Preferred compounds of the formula (Ia) where x=3 are trimethylmonomethoxysilane, trimethylmonoethoxysilane, trimethylmono-n-butoxysilane, triethylmonomethoxysilane, triethylmonoethoxysilane, triethylmono-n-butoxysilane, tri-n-propylmonomethoxysilane, tri-n-propylmonoethoxysilane, tri-n-propylmono-n-butoxysilane, tri-n-butylmonomethoxysilane, tri-n-butylmonoethoxysilane, tri-n-butylmono-n-butoxysilane, triphenylmonomethoxysilane, triphenylmonoethoxysilane, and triphenylmono-n-butoxysilane.

Particularly preferred are trimethylmonomethoxysilane, trimethylmonoethoxysilane, triethylmonomethoxysilane, and triethylmonoethoxysilane, most preferred are trimethylmonomethoxysilane and triethylmonomethoxysilane.

In a preferred embodiment, x=1 in the employed alkoxy alkyl silanes of the formula (Ia).

In a further, particularly preferred, embodiment, x=2 in the employed alkoxy alkyl silanes of the formula (Ia). i.e. pure dialkoxy dialkyl silanes are used as compounds of the formula (Ia).

In a further preferred embodiment, mixtures of alkoxy alkyl silanes of the formula (Ia) are used, more preferably mixtures of compounds where x=2 and additionally at least one further compound where x=1 and/or x=3, most preferably such mixtures in which the compounds where x=2 make up at least 50 mol % of the mixture, in particular at least 75 mol %, especially at least 85 mol %.

It may also be possible to use as starting compounds cyclic siloxanes of the formula (Ib)

—(—SIR¹₂—O—)_{y}— (Ib)
where y=3 or 4, preferably 3.

Preference is given to hexamethylcyclotrisiloxane or octamethylcyclotetrasiloxane and mixtures thereof. Hexaethylcyclotrisiloxane and octaethylcyclotetrasiloxane are conceivable, but less preferred.

Where alkoxy alkyloxy silanes of the formula (III) where x=2, in particular where R¹=methyl, are to be obtained as the desired product, it is a preferred embodiment of the present invention when cyclic siloxanes of the formula (Ib) are reacted with at least one alkoxy alkanol of the formula (II).

Mixtures of alkoxy alkyl silanes of the formula (Ia) and cyclic siloxanes of the formula (Ib) are also possible, in particular when the desired product is to consist predominantly of compounds where x=2.

In the method according to the invention, the alkoxy alkyl silanes of the formula (Ia) are preferred as starting compounds over the cyclic siloxanes of the formula (Ib).

In the at least one alkoxy alkanol of the formula (II)

R³—O—[—CH₂—CH₂—O—]ₙ—H (II)
R³ is C₁-C₄ alkyl, more preferably methyl, ethyl or n-butyl, and n is a positive integer from 2 to 5, preferably from 2 to 4, more preferably 2 or 3, and most preferably 3.

Examples of such alkoxy alkanols, which are also referred to as glycol monoalkyl ethers, are diethylene glycol monomethyl ether, diethylene glycol monoethyl ether, diethylene glycol mono-n-butyl ether, triethylene glycol monomethyl ether, triethylene glycol monoethyl ether, triethylene glycol mono-n-butyl ether, tetraethylene glycol monomethyl ether, tetraethylene glycol monoethyl ether, and tetraethylene glycol mono-n-butyl ether.

Preferred alkoxy alkanols are diethylene glycol monomethyl ether, diethylene glycol monoethyl ether, diethylene glycol mono-n-butyl ether, triethylene glycol monomethyl ether, triethylene glycol monoethyl ether, and triethylene glycol mono-n-butyl ether.

More preferred are diethylene glycol monomethyl ether, diethylene glycol monoethyl ether, triethylene glycol monomethyl ether, and triethylene glycol monoethyl ether and most preferred are triethylene glycol monomethyl ether and triethylene glycol monoethyl ether.

The alkoxy alkanols may be used individually or in a mixture; in most cases, purified individual alkoxy alkanols still contain minor amounts of higher and lower homologous alkoxy alkanols as a consequence of the method of preparation.

In a preferred embodiment, the proportion of alkoxy alkanols where n=3 in the total amount of the incorporated alkoxy alkanols in formula (III) is at least 75% by weight, particularly preferably at least 85% by weight, very particularly preferably at least 90%, and in particular at least 95% by weight.

In a further preferred embodiment, the proportion of alkoxy alkanols where n=2 in the total amount of the incorporated alkoxy alkanols in formula (III) is not more than 20% by weight, more preferably not more than 10% by weight, and most preferably not more than 5% by weight. The alkoxy alkanols where n=2 may as a consequence of the method of preparation also contain minor amounts of alkoxy alkanols where n=1. Their content in the alkoxy alkanols where n=2 is however preferably less than 7.5% by weight, more preferably less than 5% by weight, and most preferably less than 2.5% by weight. Examples of such alkoxy alkanols where n=1 are ethylene glycol monomethyl ether, ethylene glycol monoethyl ether, and ethylene glycol mono-n-butyl ether.

In a further preferred embodiment, the proportion of alkoxy alkanols where n is at least 4, not more than 15% by weight, more preferably not more than 5% by weight, and most preferably where n=4, in the total amount of the incorporated alkoxy alkanols in formula (III) is preferably not more than 3% by weight. The alkoxy alkanols where n=4 may as a consequence of the method of preparation also contain minor amounts of alkoxy alkanols where n>4. Their content in the alkoxy alkanols where n=4 is however preferably less than 5% by weight, more preferably less than 2.5% by weight, and most preferably less than 1% by weight.

The sum total of all incorporated alkoxy alkanols where n=2 to 5 in formula (III) is always 100% by weight.

The reaction of the reactants of the formulas (Ia) and/or (Ib) with the alkoxy alkanols of the formula (II) results in the organic silicon compounds of the formula (III)

R¹ₓSi(—[—O—CH₂—CH₂—]ₙ—O—R³)₄₋ₓ (III)
where the values for R¹, R³, n, and x essentially correspond to the values for the reactants used.

As a result of incomplete reaction or if a mixture of alkoxy alkanols of the formula (II) is used in which the individual alkoxy alkanols have different reactivities, the incorporation ratios in the product of the formula (III) may in the individual case diverge from the ratio of the alkoxy alkanols of the formula (II) used in the reaction.

The starting compounds of the formula (Ia) and/or (Ib) and (II) are mixed together in the desired ratio and reacted with one another.

The starting compounds may here be mixed fully with one another and heated together to the desired reaction temperature. In a preferred embodiment, the starting compounds of the formula (Ia) and/or (Ib) are initially charged and the alkoxy alkanol of the formula (II) added in several, for example two to four, preferably two or three, portions or added continuously, spread out over the reaction time. At the end of addition of the alkoxy alkanol, the reaction mixture is heated for a further period to drive the reaction to completion.

In a further preferred embodiment, the alkoxy alkanol of the formula (II) is initially charged and the starting compounds of the formula (Ia) and/or (Ib) added in several, for example two to four, preferably two or three, portions or added continuously, spread out over the reaction time. At the end of addition of the starting compounds of the formula (Ia) and/or (Ib), the reaction mixture is heated for a further period to drive the reaction to completion. This embodiment is preferable in particular when the starting compounds of the formula (Ia) and/or (Ib) have significant volatility under the reaction conditions and therefore escape to a significant degree from the liquid reaction mixture.

The at least one alkoxy alkanol of the formula (II) is used in different molar ratios depending on the starting material used:
Use of (Ia) where x=1: The alkoxy alkanol (II) is used in a molar ratio of at least 3:1, in which the molar ratio refers to the ratio of free hydroxy groups in compound (II) to silicon atoms in compound (Ia). Preferably in a ratio of at least 3.1:1, particularly preferably at least 3.2:1 to 6:1, very particularly preferably from at least 3.3:1 to 5:1, in particular at least 3.5:1 to 4:1.
Use of (Ia) where x=2 or (Ib): The alkoxy alkanol (II) is used in a molar ratio of at least 2:1, in which the molar ratio refers to the ratio of free hydroxy groups in compound (II) to silicon atoms in compound (Ia) and (Ib). Preferably in a ratio of at least 2.1:1, particularly preferably at least 2.2:1 to 5:1, very particularly preferably from at least 2.3:1 to 4:1, in particular at least 2.5:1 to 3:1.
Use of (Ia) where x=3: The alkoxy alkanol (II) is used in a molar ratio of at least 1:1, in which the molar ratio refers to the ratio of free hydroxy groups in compound (II) to silicon atoms in compound (Ia). Preferably in a ratio of at least 1.1:1, particularly preferably at least 1.2:1 to 4:1, very particularly preferably from at least 1.3:1 to 3:1, in particular at least 1.5:1 to 2:1.

In general, the alkoxy alkanol (II) is used in a molar ratio of at least 1:1 per group to be replaced (R²O—) in the compound of the formula (Ia), preferably at least 1.1:1, particularly preferably at least 1.2:1 to 4:1, very particularly preferably of at least 1.3:1 to 3:1, in particular at least 1.5:1 to 2:1.

If mixtures of compounds (Ia) having different values for x are used, the statistical mean value x′ of the alkyl groups R¹ for this mixture is determined, which is derived from the molar proportions of each individual compound and the value in each case for x for the number of alkyl groups in the respective individual compound. If the mixture still contains at least cyclic siloxane of the formula (Ib), the proportion thereof per silicon atom present therein is taken into account with x=2.

Thus, a mixture of compounds (Ia) comprising 30 mol % where x=1, 60 mol % where x=2, and 10 mol % where x=3 results for example in a statistical functionality of alkyl groups R¹ of x′=0.3*1+0.6*2+0.1*3=1.8. This results in a statistical functionality of alkoxy groups (R²O—) or Si—O bonds of (4−x′)=2.2.

A mixture of compounds (Ia) comprising 40 mol % where x=1, 40 mol % where x=2, 10 mol % where x=3, and 10 mol % of hexamethylcyclotrisiloxane results in a statistical functionality of alkyl groups R¹ of x′=0.4*1+0.4*2+0.1*3+0.1*3*2=2.1. This accordingly results in a statistical functionality of Si—O bonds of 0.4*3+0.4*2+0.1*1+0.1*3*2=2.7.

The alkoxy alkanol (II) is then used in an at least equimolar ratio based on Si—O bonds, preferably in an at least 1.1-fold excess, more preferably in a 1.2- to 4-fold excess, and most preferably in an at least 1.3- to 3-fold excess.

In a preferred embodiment of the present invention, the at least one alkoxy alkanol of the formula (II) is used in excess and left in the product at the end of the reaction. Mixtures of organic silicon compounds of the formula (III) and the at least one alkoxy alkanol of the formula (II) are obtainable in this way. These mixtures are preferably essentially composed as follows: 35-70% by weight of organic silicon compound of the formula (III) to 65-30% by weight of at least one alkoxy alkanol of the formula (II), more preferably 40-60% to 40-60% by weight, and most preferably 45-55% to 55-45% by weight, of compounds of the formula (III) to compounds of the formula (II).

Residual solvent and also residues of acid or base may also be present in minor amounts; these residues are preferably not more than 5% by weight, particularly preferably not more than 3% by weight, very particularly preferably not more than 2% by weight, and in particular not more than 1% by weight.

In one embodiment, the starting compounds are mixed with one another without further solvents, which has the advantage that no solvent needs to be removed from the reaction mixture at the end of the reaction. This is particularly preferable when the viscosity of the starting compounds and of the reaction mixture under the conditions is low enough to ensure 30 transport and mixing of the liquids.

In a further, preferred embodiment, the reaction is carried out in at least one solvent, preferably just one solvent. The at least one solvent is preferably selected from the group consisting of
open-chain or cyclic ethers,
alkanols, and
hydrocarbons.

Examples of open-chain and cyclic ethers are diethyl ether, di-n-butyl ether, tert-butyl methyl ether, tert-butyl ethyl ether, tert-amyl methyl ether, diphenyl ether, ethylene glycol dimethyl 40 ether, ethylene glycol diethyl ether, ethylene glycol di-n-butyl ether, tetrahydrofuran, and dioxane.

Examples of alkanols are C₁ to C₁₀ alkanols, preferably methanol, ethanol, isopropanol, n-propanol, n-butanol, isobutanol, sec-butanol, tert-butanol, n-hexanol, n-heptanol, 2-45 ethylhexanol, n- octanol, 2-propylheptanol, and n-decanol. When an alkanol is used as a solvent, it is a preferred embodiment when the alkanol R²OH is used as solvent.

Alkanols are preferred as solvents only when a metal alkoxide is used as the base. In this case, the preferred solvent is the alkanol that is also used in the form of the metal alkoxide. Otherwise, the use of alkanols as solvents is less preferred.

Preference is given to using hydrocarbons as solvents, examples thereof being ones that predominantly comprise aliphatic, cycloaliphatic or aromatic C₅ to C₁₄ hydrocarbons.

Preferred aromatic hydrocarbons are toluene, o-, m- or p-xylene, trimethylbenzene isomers, tetramethylbenzene isomers, ethylbenzene, cumene, tetrahydronaphthalene, and mixtures comprising such substances.

Examples of (cyclo) aliphatic hydrocarbons are decalin, alkylated decalin, and isomer mixtures of straight-chain or branched alkanes and/or cycloalkanes, in particular cyclopentane, cyclohexane, methylcyclohexane, and cycloheptane.

Preferred alkanes are n-pentane, pentane isomer mixtures, n-hexane, hexane isomer mixtures, n-heptane, heptane isomer mixtures, n-octane, octane isomer mixtures, nonane isomer mixtures, n-decane, and decane isomer mixtures.

Further examples of solvents are the Solvesso® products from ExxonMobil Chemical, particularly Solvesso® 100 (CAS No. 64742-95-6, predominantly C₉ and C₁₀ aromatics, boiling range about 154-178° C.), 150 (boiling range about 182-207° C.) and 200 (CAS No. 64742-94-5), and the Shellsol® products from Shell, Caromax® (e.g. Caromax® 18) from Petrochem Carless and Hydrosol from DHC (e.g. as Hydrosol® A 170). Hydrocarbon mixtures composed of paraffins, cycloparaffins, and aromatics are also commercially available under the Kristallöl (for example Kristallöl 30, boiling range about 158-198° C. or Kristallöl 60: CAS No. 64742-82-1), white spirit (for example likewise CAS No. 64742-82-1) or solvent naphtha (light: boiling range about 155-180° C., heavy: boiling range about 225-300° C.) designations. The aromatics content of such hydrocarbon mixtures is generally more than 90% by weight, preferably more than 95% by weight, more preferably more than 98% by weight, and most preferably more than 99% by weight. It may be advantageous to use hydrocarbon mixtures having a particularly reduced content of naphthalene.

The hydrocarbon is particularly preferably one that under the reaction conditions acts as an entraining agent for water, particularly when using cyclic siloxanes of the formula (Ib), or for the alkanol R²OH, particularly when using alkoxy alkyl silanes of the formula (Ia). Preference is given to hydrocarbons that form a heteroazeotrope and that, after distillative removal from the reaction mixture, cool to form two phases, the hydrocarbon phase of which is returned to the reaction.

The at least one solvent is particularly preferably selected from the group consisting of cyclohexane, methylcyclohexane, benzene, toluene, xylene, hexane, and heptane.

If a solvent is used, the concentration in the solution of the reactants and of the at least one acid or base is generally 10% to 90% by weight, preferably 20% to 80%, more preferably 30% to 70%, and most preferably 40% to 60% by weight.

The removal of the solvent, for example by distillation, results in the concentration increasing in the course of the reaction.

Although it is possible to carry out the reaction of the starting compounds purely thermally, reaction in the presence of at least one acid or at least one base is preferred according to the invention.

The at least one acid is preferably selected from the group consisting of
inorganic mineral acids,
organic carboxylic acids,
organic sulfonic acids, preferably alkyl or aryl sulfonic acids, and
acidic ion exchangers.

Examples of inorganic mineral acids are hydrochloric acid, nitric acid, sulfuric acid, sulfurous acid, phosphoric acid and phosphorous acid, with preference among these being given to sulfuric acid and phosphoric acid and particular preference to sulfuric acid.

Among the inorganic mineral acids, acids that have an oxidizing effect under the reaction conditions are less preferred. It is also conceivable to choose the reaction conditions for the method according to the invention such that the oxidizing effect is less pronounced, for example by lowering the reaction temperature or shortening the reaction time.

Organic carboxylic acids are C₁ to C₃₀ carboxylic acids, preferably C₂ to C₂₀ mono- or dicarboxylic acids, more preferably monocarboxylic acids.

In a preferred embodiment, the carboxylic acids are C₁ to C₁₀ monocarboxylic acids, preferably C₂ to C₆ monocarboxylic acids, more preferably C₂ to C₄ monocarboxylic acids.

In a further preferred embodiment, the carboxylic acids are C₁₀ to C₂₀ fatty acids.

Individual examples of the respective organic carboxylic acids are listed below under alkali metal and alkaline earth metal carboxylates. The preferences mentioned there apply to the organic carboxylic acids too.

Examples of organic sulfonic acids are methanesulfonic acid, ethanesulfonic acid, trifluoromethanesulfonic acid, cyclododecanesulfonic acid, benzenesulfonic acid, para-toluenesulfonic acid and singly to triply C₆-C₂₀-alkyl-substituted benzenesulfonic acids, such as nonylbenzenesulfonic acid, dodecylbenzenesulfonic acid, tetradecylbenzenesulfonic acid, hexadecylbenzenesulfonic acid or octadecylbenzenesulfonic acid.

The organic sulfonic acids are generally preferred over inorganic mineral acids.

Acidic ion exchangers are mostly ones bearing carboxylic acid or sulfonic acid groups, preferably carboxylic acid groups, in a polymer matrix, commonly a polystyrene-based, poly(meth)acrylate-based or poly(meth)acrylic acid-based polymer matrix. Among acidic ion exchangers, preference is given to weakly acidic ion exchangers, in particular those in which the acidity is determined by carboxyl groups. Very particular preference is given to those based on poly(meth)acrylic acid.

In the case of performance in the presence of at least one base, this is preferably selected from the group consisting of
alkali metal or alkaline earth metal oxides or hydroxides, preferably alkali metal hydroxides,
alkali metal or alkaline earth metal carbonates or hydrogen carbonates,
alkali metal or alkaline earth metal hydrogen sulfates,
alkali metal or alkaline earth metal phosphates, hydrogen phosphates or dihydrogen phosphates,
alkali metal or alkaline earth metal carboxylates,
metal alkoxides, preferably metal alkoxides of the alkanol R²OH, and
amines, particularly tertiary amines.

Examples of alkali metal or alkaline earth metal oxides and hydroxides are calcium oxide, magnesium oxide, calcium hydroxide, magnesium hydroxide, sodium hydroxide, potassium hydroxide, and lithium hydroxide, with preference among these being given to the alkali metal hydroxides, particular preference to sodium hydroxide and potassium hydroxide, and most preference to sodium hydroxide.

Examples of alkali metal or alkaline earth metal carbonates and hydrogen carbonates are calcium carbonate, magnesium carbonate, lithium carbonate, sodium carbonate, potassium carbonate, calcium hydrogen carbonate, magnesium hydrogen carbonate, lithium hydrogen carbonate, sodium hydrogen carbonate, and potassium hydrogen carbonate.

Among these, preference is given to the carbonates and particular preference to the alkali metal carbonates, particularly preferably sodium carbonate, sodium hydrogen carbonate, and potassium carbonate, most preferably sodium carbonate and sodium hydrogen carbonate.

Examples of alkali metal or alkaline earth metal hydrogen sulfates are calcium hydrogen sulfate, magnesium hydrogen sulfate, lithium hydrogen sulfate, sodium hydrogen sulfate, and potassium hydrogen sulfate, especially sodium hydrogen sulfate and potassium hydrogen sulfate.

Examples of alkali metal or alkaline earth metal phosphates, hydrogen phosphates or dihydrogen phosphates are calcium phosphate, magnesium phosphate, lithium phosphate, sodium phosphate, potassium phosphate, calcium hydrogen phosphate, magnesium hydrogen phosphate, lithium hydrogen phosphate, sodium hydrogen phosphate, potassium hydrogen phosphate, calcium dihydrogen phosphate, magnesium dihydrogen phosphate, lithium dihydrogen phosphate, sodium dihydrogen phosphate, and potassium dihydrogen phosphate.

Preferred examples of alkali metal or alkaline earth metal carboxylates are the sodium and potassium salts of C₁ to C₃₀ carboxylic acids, preferably C₂ to C₂₀ mono- or dicarboxylic acids, more preferably monocarboxylic acids

In a preferred embodiment, the carboxylic acids are C₁ to C₁₀ monocarboxylic acids, preferably C₂ to C₅ monocarboxylic acids, more preferably C₂ to C₄ monocarboxylic acids.

Examples of such monocarboxylic acids are acetic acid, propionic acid, n-butyric and isobutyric acid, pentanoic acid, pivalic acid, hexanoic acid, octanoic acid, 2-ethylhexanoic acid, decanoic acid, and 2-propylheptanoic acid.

In a further preferred embodiment, the carboxylic acids are C₁₀ to C₂₀ fatty acids. Examples thereof are decanoic acid (capric acid), undecanoic acid, dodecanoic acid (lauric acid), tridecanoic acid, tetradecanoic acid (myristic acid), pentadecanoic acid, palmitic acid (hexadecanoic acid), margaric acid (heptadecanoic acid), stearic acid (octadecanoic acid), palmitoleic acid [(9Z)-hexadec-9-enoic acid], oleic acid [(9Z)-octadec-9-enoic acid], elaidic acid [(9E)-octadec-9-enoic acid], erucic acid [(13Z)-docos-13-enoic acid], linoleic acid [(9Z,12Z)-octadeca-9,12-dienoic acid], linolenic acid [(9Z,12Z, 15Z)-octadeca-9,12,15-trienoic acid], eleostearic acid [(9Z,11E,13E)-octadeca-9,11,13-trienoic acid], nonadecanoic acid, and arachic acid (eicosanoic acid).

In a preferred embodiment of the present invention, metal alkoxides are used as bases, preferably metal C₁ to C₄ alkoxides, more preferably metal methoxide, ethoxide, isopropoxide, n-propoxide, n-butoxide, and tert-butoxide, most preferably the metal alkoxide of the alkanol R²OH.

Conceivable as alkoxides, although less preferred, are phenoxides, preferably the metal salts of phenol, o-, m- or p-cresol, 2-tert-butyl-4-methylphenol, 6-tert-butyl-2,4-dimethylphenol, 2,6-di-tert-butyl-4-methylphenol, 2-tert-butylphenol, 4-tert-butylphenol, 2,4-di-tert-butylphenol, 2-methyl-4-tert-butylphenol, 4-tert-butyl-2,6-dimethylphenol, hydroquinone or hydroquinone monomethyl ether.

The metals in the metal alkoxides are preferably lithium, sodium, potassium, titanium, aluminum, zirconium, iron, cobalt, nickel, and zinc, more preferably lithium, sodium, potassium, aluminum, and titanium.

Very particular preference is given to sodium methoxide, sodium ethoxide, potassium methoxide, potassium ethoxide, potassium tert-butoxide, aluminum tri (isopropoxide), titanium tetra(n-butoxide), and titanium tetra(isopropoxide).

Examples of tertiary amines/amines having at least one nitrogen atom with three substituents that may be used include trimethylamine, triethylamine, tri-n-butylamine, tri-n-hexylamine, tri-n-octylamine, dimethylethanolamine, triethanolamine, N-methylmorpholine, N-methylpiperidine, N-methylpyrrolidine, pyridine, dimethylaminopyridine, dimethylaniline, 1,4-diazabicyclo[2.2.2]octane (triethylenediamine, DABCO), 1,5-diazabicyclo[4.3.0]non-5-ene (DBN), and 1,8-diazabicyclo[5.4.0]undec-7-ene (DBU).

Preference is given to tri-n-butylamine, pyridine, dimethylaminopyridine, 1,4-diazabicyclo[2.2.2]octane (triethylenediamine, DABCO), 1,5-diazabicyclo[4.3.0]non-5-ene (DBN), and 1,8- diazabicyclo[5.4.0]undec-7-ene (DBU).

The at least one acid or at least one base are generally used in amounts of 5 to 30 mol % based on silicon atoms in compound (Ia) and (Ib), preferably 10 to 25 mol %.

The reaction temperature is from 0 (zero) to 200° C. preferably from 40 to 190° C., particularly preferably from 50 to 180° C., very particularly preferably from 60 to 170° C., and in particular from 70 to 160° C. In a preferred embodiment, the reaction temperature is increased in the course of the reaction, for example by up to 80° C., preferably by up to 60′° C. and more preferably by up to 50° C. This is particularly preferable when the minor component of the starting compounds is converted to an extent of at least 50%, preferably to an extent of at least 70%, and more preferably to an extent of at least 80%, so that the reaction proceeds to completion through the increase in temperature.

It may be advantageous to carry out the reaction at an overpressure, for example up to 20, preferably up to 15, and more preferably up to 10, bar overpressure. This is particularly preferable when at least one of the starting compounds has a boiling point that is about 30° C., preferably 20° C., below the reaction temperature.

If the boiling points of the starting compounds are sufficiently far apart from the desired reaction temperature, the reaction is preferably carried out at standard pressure.

To remove volatile constituents formed in the course of the reaction and solvent optionally used, an underpressure of at least 100 mbar below ambient pressure can preferably be applied, more preferably at least 200 mbar, and most preferably at least 500 mbar below ambient pressure; preferably, the underpressure is increased in the course of the reaction and removal of the volatile constituents to a final pressure of 200 mbar, preferably 100 mbar, more preferably 50 mbar, and most preferably 20 mbar.

Solvent removed, which may contain volatile acids or bases, can then be reused for a subsequent run of the reaction.

In a preferred embodiment, volatile constituents formed in the course of the reaction and solvent optionally used are removed by stripping with an inert gas, preferably by passing this through the reaction mixture.

Examples of gases that are inert under the reaction conditions are nitrogen, argon, carbon dioxide or oxygen-depleted air having an oxygen content of less than 10% by volume, preferably less than 8% by volume, more preferably less than 5% by volume, preferably nitrogen or argon, more preferably nitrogen.

The inert gas may be introduced through dip tubes, ring lines, nozzles or frits.

It can furthermore be helpful to add to the reaction mixture at least one antioxidant, preferably at least one phenolic compound. One of the effects of the antioxidant is to increase the yield of the reaction.

Examples of phenolic compounds are alkylphenols, for example o-, m- or p-cresol (methylphenol), 2-tert-butyl-4-methylphenol, 6-tert-butyl-2,4-dimethylphenol, 2,6-di-tert-butyl-4-methylphenol, 2-tert-butylphenol, 4-tert-butylphenol, 2,4-di-tert-butylphenol, 2-methyl-4-tert-butylphenol, 4-tert-butyl-2,6-dimethylphenol, or 2,2′-methylenebis(6-tert-butyl-4-methylphenol), 4,4′-oxydiphenyl, 3,4-methylenedioxydiphenol (sesamol), 3,4-dimethylphenol, hydroquinone, catechol (1,2-dihydroxybenzene), 2-(1′-methylcyclohex-1′-yl)-4,6-dimethylphenol, 2- or 4-(1-phenyl-eth-1′-yl)-phenol, 2-tert-butyl-6-methylphenol, 2,4,6-tris-tert-butylphenol, 2,6-di-tert-butylphenol, 2,4-di-tert-butylphenol, 4-tert-butylphenol, nonylphenol[11066-49-2], octylphenol[140-66-9], 2,6-dimethylphenol, bisphenol A, bisphenol F, bisphenol B, bisphenol C, bisphenol S, 3,3′,5,5′-tetrabromobisphenol A, 2,6-di-tert-butyl-p-cresol, Koresin® from BASF SE, methyl 3,5-di-tert-butyl-4-hydroxybenzoate, 4-tert-butylcatechol, 2-hydroxybenzyl alcohol, 2-methoxy-4-methylphenol, 2,3,6-trimethylphenol, 2,4,5-trimethylphenol, 2,4,6-trimethylphenol, 2-isopropylphenol, 4-isopropylphenol, 6-isopropyl-m-cresol, n-octadecyl P-(3,5-di-tert-butyl-4-hydroxyphenyl)propionate, 1,1,3-tris-(2-methyl-4-hydroxy-5-tert-butylphenyl)butane, 1,3,5-trimethyl-2,4,6-tris-(3,5-di-tert-butyl-4-hydroxybenzyl)benzene, 1,3,5-tris-(3,5-di-tert-butyl-4-hydroxybenzyl)isocyanurate, 1,3,5-tris-(3,5-di-tert-butyl-4-hydroxyphenyl)propionyloxyethyl isocyanurate, 1,3,5-tris-(2,6-dimethyl-3-hydroxy-4-tert-butylbenzyl) isocyanurate or pentaerythritol tetrakis[p-(3,5,-di-tert-butyl-4-hydroxyphenyl)propionate], 2,6-di-tert-butyl-4-dimethylaminomethylphenol, 6-isobutyl-2,4-dinitrophenol, 6-sec-butyl-2,4-dinitrophenol, Irganox®565, 1141, 1192, 1222, and 1425 from BASF SE, octadecyl 3-(3′,5′-di-tert-butyl-4′-hydroxyphenyl)propionate, hexadecyl 3-(3′,5′-di-tert-butyl-4′-hydroxyphenyl)propionate, octyl 3-(3′,5′-di-tert-butyl-4-hydroxyphenyl)propionate, 3-thia-1,5-pentanadiolbis-[(3′,5′-di-tert-butyl-4′-hydroxyphenyl)propionate], 4,8-dioxa-1,11-undecanediol-bis[(3′,5′-di-tert-butyl-4′-hydroxyphenyl)propionate], 4,8-dioxa-1,11-undecanediol-bis-[(3′-tert-butyl-4′-hydroxy-5′-methylphenyl)propionate], 1,9-nonanediol-bis-[(3′,5′-di-tert-butyl-4′-hydroxyphenyl)propionate], 1,7-heptanediaminebis[3-(3′,5′-di-tert-butyl-4′-hydroxyphenyl)propionamide], 1,1-methanediaminebis[3-(3′,5′-di-tert-butyl-4′-hydroxyphenyl)propionamide], 3-(3′,5′-di-tert-butyl-4′-hydroxyphenyl)propionic hydrazide, 3-(3′,5′-di-methyl-4′-hydroxyphenyl) propionic hydrazide, bis(3-tert-butyl-5-ethyl-2-hydroxyphen-1-yl)methane, bis(3,5-di-tert-butyl-4-hydroxyphen-1-yl)methane, bis[3-(1′-methylcyclohex-1′-yl)-5-methyl-2-hydroxyphen-1-yl]methane, bis(3-tert-butyl-2-hydroxy-5-methylphen-1-yl)methane, 1,1-bis(5-tert-butyl-4-hydroxy-2-methyl-phen-1-yl)ethane, bis(5-tert-butyl-4-hydroxy-2-methyl-phen-1-yl) sulfide, bis(3-tert-butyl-2-hydroxy-5-methyl-phen-1-yl) sulfide, 1,1-bis(3,4-dimethyl-2-hydroxyphen-1-yl)-2-methylpropane, 1,1-bis(5-tert-butyl-3-methyl-2-hydroxyphen-1-yl)-butane, 1,3,5-tris[1′-(3″,5″-di-tert-butyl-4″-hydroxyphen-1-yl)-meth-1′-yl]-2,4,6-trimethylbenzene, 1,1,4-tris(5-tert-butyl-4′-hydroxy-2′-methyl-phen-1-yl)butane, aminophenols, for example para-aminophenol, 3-diethylarninophenol, nitrosophenols, for example para-nitrosophenol, p-nitroso-o-cresol, alkoxyphenols, for example 2-methoxyphenol (guaiacol, catechol monomethyl ether), 2-ethoxyphenol, 2-isopropoxyphenol, 4-methoxyphenol (hydroquinone monomethyl ether), mono- or di-tert-butyl-4-methoxyphenol, 3,5-di-tert-butyl-4-hydroxyanisole, 3-hydroxy-4-methoxybenzyl alcohol, 2,5-dimethoxy-4-hydroxybenzyl alcohol (syringa alcohol), 4-hydroxy-3-methoxybenzaldehyde (vanillin), 4-hydroxy-3-ethoxybenzaldehyde (ethylvanillin), 3-hydroxy-4-methoxybenzaldehyde (isovanillin), 1-(4-hydroxy-3-methoxyphenyl)ethanone (acetovanillone), eugenol, dihydroeugenol, isoeugenol, tocopherols, for example α-, β-, γ-, δ- and ε-tocopherol, tocol, α-tocopherol hydroquinone, and also 2,3-dihydro-2,2-dimethyl-7-hydroxybenzofuran (2,2-dimethyl-7-hydroxycoumarin), Trolox®, gallic acid, ferulic acid, cinnamic acid and derivatives thereof, hydroquinone or hydroquinone monomethyl ether, 2,5-di-tert-butylhydroquinone, 2-methyl-p-hydroquinone, 2,3-dimethylhydroquinone, 65 trimethylhydroquinone, 4-methylcatechol, tert-butylhydroquinone, 3-methylcatechol, benzoquinone, 2-methyl-p-hydroquinone, 2,3-dimethylhydroquinone, trimethylhydroquinone, 3-methylcatechol, 4-methylcatechol, tert-butylhydroquinone, 4-ethoxyphenol, 4-butoxyphenol, hydroquinone monobenzyl ether, p-phenoxyphenol, 2-methylhydroquinone, 2,5-di-tert-butylhydroquinone, tetramethyl-p-benzoquinone, diethyl 1,4-cyclohexandione-2,5-dicarboxylate, phenyl-p-benzoquinone, 2,5-dimethyl-3-benzyl-p-benzoquinone, 2-isopropyl-5-methy-p-benzoquinone (thymoquinone), 2,6-diisopropyl-p-benzoquinone, 2,5-dimethyl-3-hydroxy-p-benzoquinone, 2,5-dihydroxy-p-benzoquinone, embelin, tetrahydroxy-p-benzoquinone, 2,5-dimethoxy-1,4-benzoquinone, 2-amino-5-methyl-p-benzoquinone, 2,5-bisphenylamino-1,4-benzoquinone, 5,8-dihydroxy-1,4-naphthoquinone, 2-anilino-1,4-naphthoquinone, anthraquinone, N,N-dimethylindoaniline, N,N-diphenyl-p-benzoquinone diimine, 1,4-benzoquinone dioxime, coerulignone, 3,3′-di-tert-butyl-5,5-dimethyldiphenoquinone, p-rosolic acid (aurin), 2,6-di-tert-butyl-4-benzylidenebenzoquinone, 2,5-di-tert-amylhydroquinone, 3-ethyl-1,5-dimethyl-1H-pyrazol-4-ol.

When the desired conversion is reached or nearly reached and a solvent has been used, the solvent can be removed from the reaction mixture, preferably by distillation or rectification, optionally aided by stripping with an inert gas. This can be done preferably by increasing the temperature of the reaction mixture and/or lowering the pressure, preferably by a combination of these two measures. This increase in temperature generally drives the reaction to completion.

A single-stage distillation may be carried out either from the reactor or by passage through a suitable unit, such as a rotary evaporator, thin-film evaporator, falling-film evaporator, wiper-blade evaporator, Sambay evaporator, etc. and combinations thereof.

A rectification is preferably carried out via distillation columns fitted on the reactor, such as tray columns, which may if desired be equipped with internals, valves, side draws, etc. The distillation column(s) used may be realized in a design known per se (see for example Sattler, Thermische Trennverfahren [Thermal separation processes], 2nd edition 1995, Weinheim, p. 135 ff; Perry's Chemical Engineers Handbook, 7th edition 1997, New York, section 13). The distillation columns used may contain separating internals, such as separation trays, for example perforated trays, bell trays or valve trays, ordered packings, for example sheet metal or fabric packings, or irregularly arranged beds of random packings. Up to 20, preferably up to 10, theoretical separation trays are as a rule sufficient.

In one particular embodiment of the present invention, the reaction is carried out in the form of a reactive distillation.

In this case, the reaction of the starting compounds takes place to a significant extent or even completely on the separating internals of the separation column. Since the alkanol R²OH formed as a product is generally the most low-boiling component in the reaction system, this is removed directly from the reaction equilibrium by distillation immediately after formation, thereby allowing the reaction to progress under relatively mild conditions. The number of theoretical plates is here chosen such that the other low-boiling compounds, generally the alkoxy alkyl silane of the formula (Ia) and the cyclic siloxane of the formula (Ib), remain in the reaction mixture.

In an embodiment of the reactive distillation, the separating internals are in this case coated with an acid or a base in order to drive the reaction forward. This has the advantage that no significant reaction takes place as long as the reaction mixture is not in direct contact with the separating internals. This also results in a suppression of side reactions or further reactions that are promoted by the presence of acid or base.

In order to increase the contact of the reactants with the separating internals, a portion from the distillation receiver is withdrawn and supplied to the internals as a return flow, optionally supplemented by fresh, unreacted alkoxy alkanol of the formula (II). In a further embodiment of the reactive distillation, the at least one acid or at least one base is supplied together with the return flow to the separating internals. This has the advantage that the acid or base is also present in the distillation receiver and the reaction takes place not just on the separating internals, but also in the receiver, which increases the space-time yield.

The at least one alkoxy alkanol of the formula (II) and the product of the formula (III) are generally the highest boiling components in the reaction mixture, whereas the reactants of the formulas (Ia) and/or (Ib) and the alkanol R²OH that is formed are lower boiling. During the reaction, the reactants of the formulas (la) and/or (Ib) should be available to the reaction, i.e. maintained in the reaction mixture, whereas the alkanol R²OH formed is preferably removed from the reaction mixture. It is therefore a preferred embodiment when reaction conditions and components are chosen such that the alkanol R²OH is the lowest-boiling compound in the system and the boiling points of the reactants of the formulas (la) and/or (Ib) lie between those of R²OH and alkoxy alkanol of the formula (II) and the product of the formula (III).

In this case, it is a particularly preferred embodiment when the reaction is carried out in a reactor fitted with a rectification column, the separation performance of which ensures adequate removal of the alkanol R²OH as a low boiler at the column head, whereas the components in the reaction mixture that are higher boiling than R²OH, in particular the reactants of the formulas (Ia) and/or (Ib), are returned to the reaction mixture as a column return flow. If the reaction mixture additionally contains a solvent, this can preferably likewise be returned to the reaction mixture as a return flow or else withdrawn together with the alkanol R²OH as overhead product. If solvent and alkanol and water that is formed give rise to a two-phase mixture after condensing, the solvent phase can be returned to the reaction mixture after separation of the phases.

This embodiment is particularly preferred when dimethoxydimethylsilane (boiling point 81° C.) or dimethoxydiethylsilane is used as the alkoxy alkyl silane of the formula (Ia). In this case, methanol is at standard pressure given off at a boiling point of 65° C. and can be separated from dimethoxydimethylsilane by rectification or at least depleted.

This embodiment is particularly preferred when diethoxydimethylsilane (boiling point 113-114° C.) or diethoxydiethylsilane (boiling point approx. 159° C.) is used as the alkoxy alkyl silane of the formula (Ia). In this case, ethanol is at standard pressure given off at a boiling point of 78° C. and can be separated from diethoxydimethylsilane and from diethoxydiethylsilane by rectification or at least depleted.

This embodiment is particularly preferred when the cyclic siloxane of the formula (Ib) used is hexamethylcyclotrisiloxane (boiling point 134° C.) or octamethylcyclotetrasiloxane (boiling point 175-176° C.). In this case, water is at standard pressure given off at a boiling point of 100° C. and can be separated by rectification or at least depleted.

At the end of the reaction, unreacted reactants of the formulas (Ia) and/or (Ib) and any solvent present are then removed from the reaction mixture by distillation.

After removal of the solvent, the reaction mixture is purified.

When the desired conversion has been achieved and no solvent has been employed, the reaction is generally stopped by cooling and the reaction mixture purified. The reaction mixture is left at a temperature at which it has a viscosity sufficiently low for the purification.

The purification removes the at least one acid or base at the end of the reaction and also any solvent still present, through at least one of the purification steps selected from the group consisting of
filtration,
membrane filtration,
reverse osmosis,
sorption on at least one inorganic metal oxide or activated carbon, and
contact with at least one acidic, basic or mixed ion exchanger.

The first three techniques are familiar to those skilled in the art.

Sorption can be carried out on inorganic materials, for example silica gel, silicates, alumina, zeolites, diatomaceous earth, mixed aluminum/silicon oxides, and also calcium carbonates and oxides, or on activated carbon or charcoal.

Basic materials are preferably used for the removal of acids and vice versa.

Acids are preferably removed by passing the reaction mixture through basic ion exchangers and bases removed by passing the reaction mixture through acidic ion exchangers.

Once it has been purified, the reaction mixture is essentially free of acids, bases, and solvents and can be used as or in functional fluids, preferably hydraulic or brake fluids, and for trapping water.

For the intended use, it may be necessary to add further typical additives to the reaction mixture. Examples thereof are corrosion inhibitors, antifoams, pH stabilizers or antioxidants.

It is an advantage of the described method of the invention that the reaction mixtures can be obtained under mild conditions. In particular, the reaction mixtures are free of halides, in particular chlorides, which means that the reaction mixtures show lower corrosiveness than the corresponding compounds obtained from the corresponding alkyl chlorosilanes. The content of halides, in particular chlorides, in the reaction mixtures thus obtained is generally not more than 100 ppm by weight, preferably not more than 75, particularly preferably not more than 50, very particularly preferably not more than 25, in particular not more than 15, and even not more than 10, ppm by weight.

### EXAMPLES

### General Procedure (Example 1)

40 ml of cyclohexane was added to a three-necked flask with water separator, reflux condenser, thermometer, and nitrogen inlet. To this was then added triethylene glycol monomethyl ether (50.0 g, 0.30 mol, 2.0 equiv.), dimethoxydimethylsilane (18.3 g, 0.15 mol, 1.0 equiv.), and sodium methoxide (0.40 g, 7.5 mmol, 5 mol %).

The mixture was stirred at room temperature for 5 minutes and then heated to reflux for 6.5 hours. After cooling to room temperature, the crude product was purified by vacuum distillation (22 to 160° C., 0.24 mbar).

The product fraction (21.0 g, 57 mmol, 37% isolated yield) passed over at 142° C. and 0.24 mbar as a colorless liquid. The structure was confirmed by NMR and high-resolution mass spectrometry (HRMS).

HRMS: expected 402.2518 [M+NH₄]⁺, found 402.2514.

¹H NMR (500 MHz, CDCl₃): δ=0.02 (s, 6H), 3.25 (s, 6H), 3.42 (m, 4H), 3.46 (t, J=5.3 Hz, 4H), 3.50-3.60 (m, 12H), 3.71 (t, J=5.3 Hz, 4H),

¹³C NMR (125 MHz, CDCl₃): δ=−3.5, 55.6, 61.4, 70.1, 70.20, 70.23, 71.5, 72.0,

²⁹Si NMR (99 MHz, CDCl₃): δ=−1.85

### Example 2—Variation of the Starting Material

In analogous manner to example 1, the starting materials specified in the table were reacted with triethylene glycol monomethyl ether (MTG-OH) in a molar ratio of 2:1 at the specified temperature for the stated time.

The yield was determined in the reaction mixture by ¹H NMR, assuming that only product and unreacted triethylene glycol monomethyl ether are present in the reaction mixture.

| | | | | | t | |
|---|---|---|---|---|---|---|
| No. | Si compound | MTG-OH:Si | Cat. | T [° C.] | [h] | Yield |
| 1 | Me₂Si(OMe)₂ | 2 | NaOMe | 76° C. | 6 | 50% |
| 2 | Me₂Si(OEt)₂ | 2 | NaOEt | 86-98° C. | 5.5 | 55% |
| 3 | D3 | 2 | NaOMe | 120° C. | 6 | 5% |
| 4 | D4 | 2 | NaOMe | 115° C. | 6 | 6% |

D3: Hexamethylcyclotrisiloxane
D4: Octamethylcyclotetrasiloxane

### Example 3—Variation of the Catalyst

In analogous manner to example 1, diethoxydimethylsilane was reacted with 2.0 equivalents of triethylene glycol monomethyl ether in the presence of the catalysts specified in the table in the specified amount at 126° C. for the stated time.

As in example 2, the yield was determined in the reaction mixture by ¹H NMR.

| No. | Catalyst | Amount | | t [h] | Yield |
|---|---|---|---|---|---|
| a | — | | | 5.5 | 34% |
| b | NaOEt | 5 | mol % | 5.5 | 55% |
| c | Ti(OnBu)₄ | 5 | mol % | 5.5 | 51% |
| d | NaHCO₃ | 5 | mol % | 12 | 63% |
| e | p-TosOH | 5 | mol % | 5.5 | 64% |
| f | MSA | 5 | mol % | 5.5 | 69% |
| q | Al(OiPr)₃ | 5 | mol % | 5.5 | 65% |
| h | K₂CO₃ | 5 | mol % | 5.5 | 67% |
| i | KHSO₄ | 5 | mol % | 5.5 | 60.6% |
| j | Na phenolate | 5 | mol % | 5.5 | 54.8% |
| k | NaHSO₄ | 5 | mol % | 5.5 | 56.0% |
| l | NaHCO₃/DMAP | 5/5 | mol % | 5.5 | 62.9% |
| m | Ion exchanger | 5 | wt. % | 5.5 | 58.0% |
| n | H₃CCOONa | 5 | mol % | 5.5 | 61.3% |
| o | DMAP | 5 | mol % | 5.5 | 53% |

p-TosOH: para-Toluenesulfonic acid
MSA: Methylsulfonic acid
DMAP: 4-(Dimethylamino)pyridine
Ion exchanger: Amberlite ® CG50 (weakly acidic)

### Example 4—Variation of the Alkoxy Alkanol

In analogous manner to example 1, diethoxydimethylsilane was reacted with 2.0 equivalents of the listed alkoxy alkanol in the presence of 5 mol % of sodium ethoxide at 135° C. for 2.5 hours and then a reduced pressure of 100 mbar was applied for a further hour.

The yield refers to the isolated yield, the purity was determined by NMR.

| | | Yield | Purity |
|---|---|---|---|
| No. | Alkoxy alkanol | [%] | [%] |
| 1 (*) | Monoethylene glycol monomethyl | 30 | >95 |
| | ether | | |
| 2 | Diethylene glycol monomethyl ether | 59 | 69 |
| 3(**) | Triethylene glycol monomethyl ether | 55(***) | |

(*) Comparison
(**)Example 3, No. b
(***)Determined by NMR

Higher alkoxy alkanols where n=2 and n=3 are found to afford higher yields in the reaction than monoethylene glycol monomethyl ether.

### Example 5—Variation of the Amount of Catalyst and Amount of Alkoxyalkanol

In analogous manner to example 1, diethoxydimethylsilane was reacted with the stated equivalents of triethylene glycol monomethyl ether (MTG-OH) in the presence of 1 mol % of sodium hydrogen carbonate (NaHCO₃) at 126° C. for the time shown.

In some experiments, 1000 ppm of an antioxidant (dissolved in triethylene glycol monomethyl ether), was additionally added to the reaction mixture as per the table.

As in example 2, the yield was determined in the reaction mixture by ¹H-NMR.

| | Amount of | | | |
|---|---|---|---|---|
| No | MTG-OH [eq.] | Addition | t [h] | Yield |
| a | 2 | — | 5.5 | 59.2% |
| b | 2.5 | — | 5.5 | 58.6% |
| c | 3 | — | 5.5 | 53.7% |
| d | 3 | — | 5.5 | 54.3% |
| e | 3 | — | 5.5 | 58.3% |
| f | 2 | MeHQ | 5.5 | 68.8% |
| q | 2 | EDP | 5.5 | 73.7% |
| h | 2 | BHT | 5.5 | 68.6% |

MeHQ: Hydroquinone monomethyl ether
EDP: 3-Ethyl-1,5-dimethyl-1H-pyrazol-4-ol
BHT: tert-Butylhydroxytoluene

It can be seen that the addition of antioxidant increases the yield significantly.

1. A method for preparing organic silicon compounds of the formula (III)
R¹ₓSi(—[—O—CH₂—CH₂—]ₙ—O—R³)₄₋ₓ (III)
or mixtures thereof, the method comprising:
reacting at least one alkoxy alkyl silane of the formula (Ia)
R¹ₓSi(OR²)₄₋ₓ (Ia)
and/or a cyclic siloxane of the formula (Ib)
—(—SiR¹₂—O—)_{y}— (Ib)
with at least one alkoxy alkanol of the formula (II)
R³—O—[—CH₂CH₂—O—]ₙ—H (II)
in the presence of at least one acid or at least one base,
optionally in a solvent,
at a temperature of 0 to 200° C.,
wherein R¹ is phenyl or C₁-C₄ alkyl, R² is C₁-C₄ alkyl, R³ is C₁-C₄ alkyl, x is a positive integer 1, 2 or 3, y is a positive integer 3 or 4, and n is a positive integer from 2 to 5.

2. The method according to claim 1, wherein only compounds where x=2 are used as alkoxy alkyl silanes of the formula (Ia).

3. The method according to claim 1, wherein the at least one alkoxy alkanol of the formula (II) is used in a molar ratio of at least 1:1 per group to be replaced (R²O—) in the compound of the formula (Ia).

4. The method according to claim 1, wherein the reacting is in the solvent, and wherein the at least one solvent is at least one selected from the group consisting of
open-chain or cyclic ethers,
alkanols, and
hydrocarbons.

5. The method according to claim 4, wherein the solvent is an alkanol R²OH.

6. The method according to claim 4, wherein the solvent is a hydrocarbon that under the reaction conditions acts as an entraining agent for water and/or alkanol R²OH.

7. The method according to claim 6, wherein the hydrocarbon is cyclohexane, methylcyclohexane, benzene, toluene, xylene, hexane or heptane.

8. The method according to claim 1, wherein the reaction is carried out in the presence of at least one base selected from the group consisting of
alkali metal or alkaline earth metal oxides or hydroxides,
alkali metal or alkaline earth metal carbonates or hydrogen carbonates,
alkali metal or alkaline earth metal hydrogen sulfates,
alkali metal or alkaline earth metal phosphates, hydrogen phosphates or dihydrogen phosphates,
alkali metal or alkaline earth metal carboxylates,
metal alkoxides, and
amines.

9. The method according to claim 1, wherein the reaction is carried out in the presence of at least one acid selected from the group consisting of
inorganic mineral acids,
organic carboxylic acids,
organic sulfonic acids, and
acidic ion exchangers.

10. The method according to claim 1, wherein volatile constituents formed in the reaction and solvent optionally used are removed by applying an underpressure of at least 100 mbar below ambient pressure.

11. The method according to claim 1, wherein volatile constituents formed in the reaction and solvent optionally used are removed by stripping with an inert gas.

12. The method according to claim 1, wherein the reaction is carried out in a reactor fitted with a rectification column, the separation performance of which ensures adequate removal of an alkanol R²OH as a low boiler at the column head, and the components into the reaction mixture that are higher boiling than alkanol R²OH.

13. The method according to claim 12, wherein the alkoxy alkyl silane of the formula (Ia) is selected from the group consisting of dimethoxydimethylsilane, dimethoxydiethylsilane, diethoxydimethylsilane, and diethoxydiethylsilane.

14. The method according to claim 1, wherein the at least one alkoxy alkanol of the formula (II) is introduced into the reaction in several portions or continuously over the course of the reaction.

15. The method according to claim 1, wherein the starting compounds of the formula (Ia) and/or (Ib) are introduced into the initially charged alkoxy alkanol of the formula (II) in several portions or continuously over the course of the reaction.

16. The method according to claim 1, wherein the reaction temperature is increased in the course of the reaction.

17. The method according to claim 1, wherein the at least one acid or the at least one base is removed at the end of the reaction through at least one of the purification steps selected from the group consisting of filtration,
membrane filtration,
reverse osmosis,
sorption on at least one inorganic metal oxide or activated carbon, and
contact with at least one acidic, basic or mixed ion exchanger.

18. The method according to claim 1, wherein an excess of the at least one alkoxy alkanol of the formula (II) is left in the reaction mixture.

19. A functional fluid, comprising:
a reaction mixture obtained by the method according to claim 1.
